(19) United States
(12) Patent Application Publication
(10) Pub. No.: US 2011/0072933 A1
(43) Pub. Date: Mar. 31, 2011

(54) LEVER LOCKOUT ASSEMBLY

(76) Inventor: Dean Arden Boyce, Waterloo, IA (US)

(21) Appl. No.: 12/567,848

(22) Filed: Sep. 28, 2009

(51) Int. Cl. G05G 5/06

(52) U.S. Cl. 74/532

(57) ABSTRACT

A lever lockout assembly includes a housing, a lever support mounted on the housing, a lockout support mounted on the housing, a lever member, and lockout member pivotally supported by the lockout support. The lever member has a pivot plate and a lip projecting from the pivot plate. The pivot plate is rotatably supported by the lever support, and the pivot plate has notch formed in an outer surface thereof. The lockout member is pivotal to a lockout position wherein the lip is received by the notch, and to an unlocked position wherein the lip is outside of the notch and the pivot plate is rotatable. A lockout spring member projects from the lockout member and extends through a U-shaped slot in a cover of the housing.

### FIELD OF THE INVENTION

The present invention relates to a lever lockout assembly.

### BACKGROUND OF THE INVENTION

Tractors and other utility vehicles are typically equipped with control levers which control the operation of devices, such as selective control valves (SCV). In many markets regulations require mechanisms which can secure such levers in a neutral position, such as when the vehicle is in transport or when the SCV is not being used. Such a mechanism can prevent activation of the SCV as a result of accidental contact with the lever or as a result of vibration.

Some SCV lever lockout mechanisms have included sliding lockout members, and the sliding motion can be hindered by friction and contamination. It is desired to have a lockout mechanism which has a lockout member which pivots instead of sliding.

### SUMMARY OF THE INVENTION

Accordingly, an object of this invention is to provide a lever lockout assembly which includes a pivoting lockout member.

This and other objects are achieved by the present invention, wherein a lever lockout assembly includes a housing, a lever support mounted on the housing, a lockout support mounted on the housing, a lever member, and lockout member pivotally supported by the lockout support. The lever member has a pivot plate and a lip projecting from the pivot plate. The pivot plate is rotatably supported by the lever support, and the pivot plate has notch formed in an outer surface thereof. The lockout member is pivotal to a lockout position wherein the lip is received by the notch, and to an unlocked position wherein the lip is outside of the notch and the pivot plate is rotatable. A lockout spring member projects from the lockout member and extends through a U-shaped slot in a cover of the housing.

The lockout slot is a U-shaped slot having a main slot and first and second end slots extending transversely with respect to the main slot. The lockout spring member is biased to engage an end of the first end slot when the lockout member is in the unlocked position, and is biased to engage an end of the second end slot when the lockout member is in the locked position. The lockout member has a substantially L-shaped cross sectional shape.

### BRIEF DESCRIPTION OF THE DRAWINGS

FIG. 1 is a top perspective view of a vehicle control console including the present invention;

FIG. 2 is a top perspective of the control console of FIG. 1 with the cover removed showing the lockout member in a locked position;

FIG. 3 is a perspective view of the control console of FIG. 2 showing the lockout member in an unlocked position;

FIG. 4 is a enlarged detailed side view showing the slot in the base of one of the levers of FIG. 2.

FIG. 5 is a partially sectional perspective view of the lever lockout mechanism showing how the lockout member is pivotal supported by the housing;

FIG. 6 is a perspective view of the lockout member of FIGS. 1-5;

FIG. 7 is a perspective showing the housing lockout slot and showing the spring arm in an unlocked position; and

FIG. 8 is a perspective showing the housing lockout slot and showing the spring arm in a locked position.

### DESCRIPTION OF THE PREFERRED EMBODIMENT

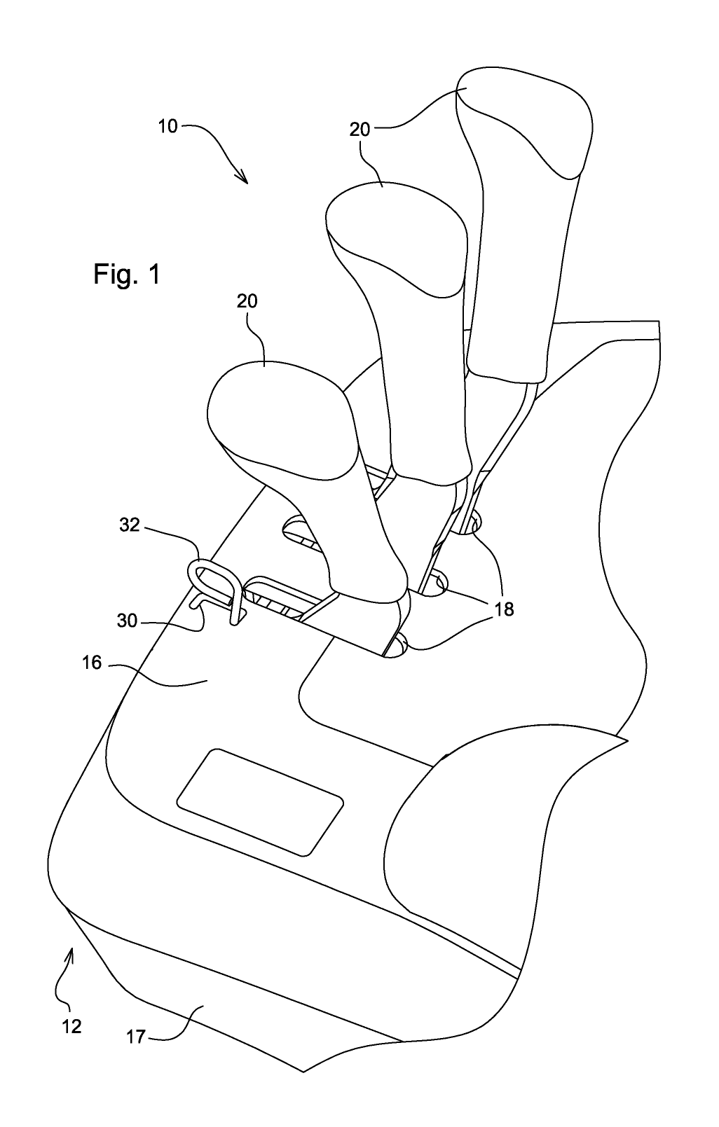

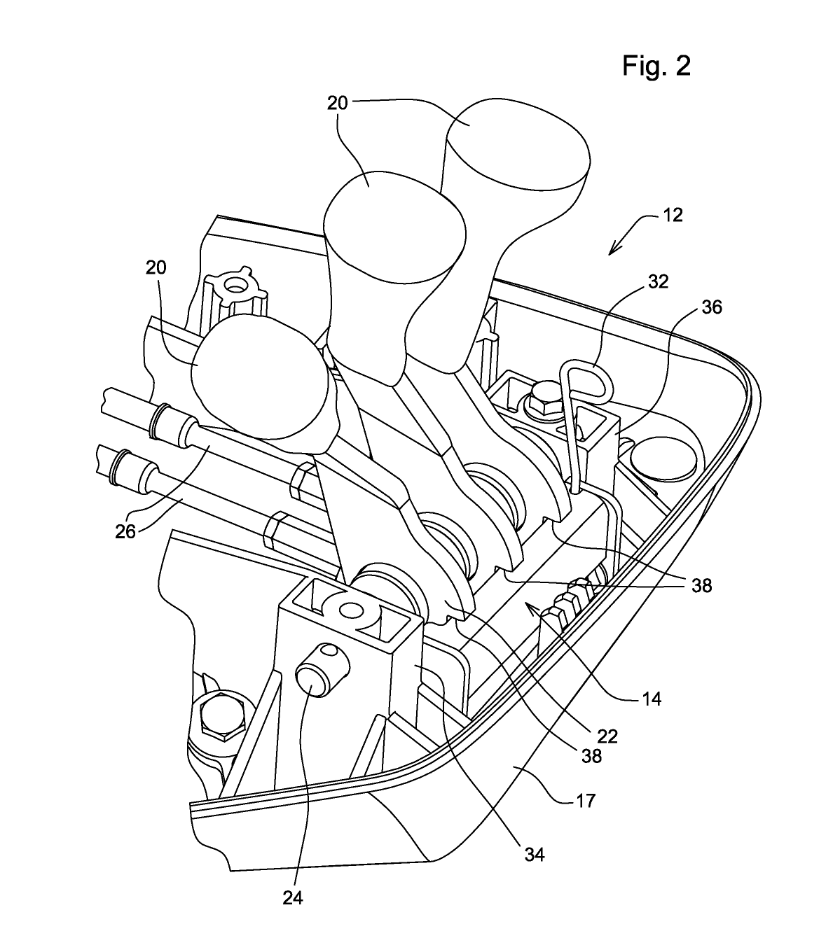

Referring to FIGS. 1-3, a control console 10, for a vehicle (not shown) such as an agricultural tractor or utility vehicle, includes a housing 12 with an upper cover 16 and a lower cover 17. The cover 16 has a plurality of lever slots 18 through which project control levers 20. A lower part 22 of each control lever 20 is preferably pivotal on a pivot pin 24 and is coupled to a conventional linkage 26 (see FIG. 2), which is in turn, operatively coupled to a controlled device, such as a conventional selective control valve (not shown). The cover 16 also has a U-shaped slot 30 though which extends a spring arm 32 for manipulation by an operator. A lockout member 14, preferably made out of steel, is pivotally supported in the housing 12 adjacent the levers 20.

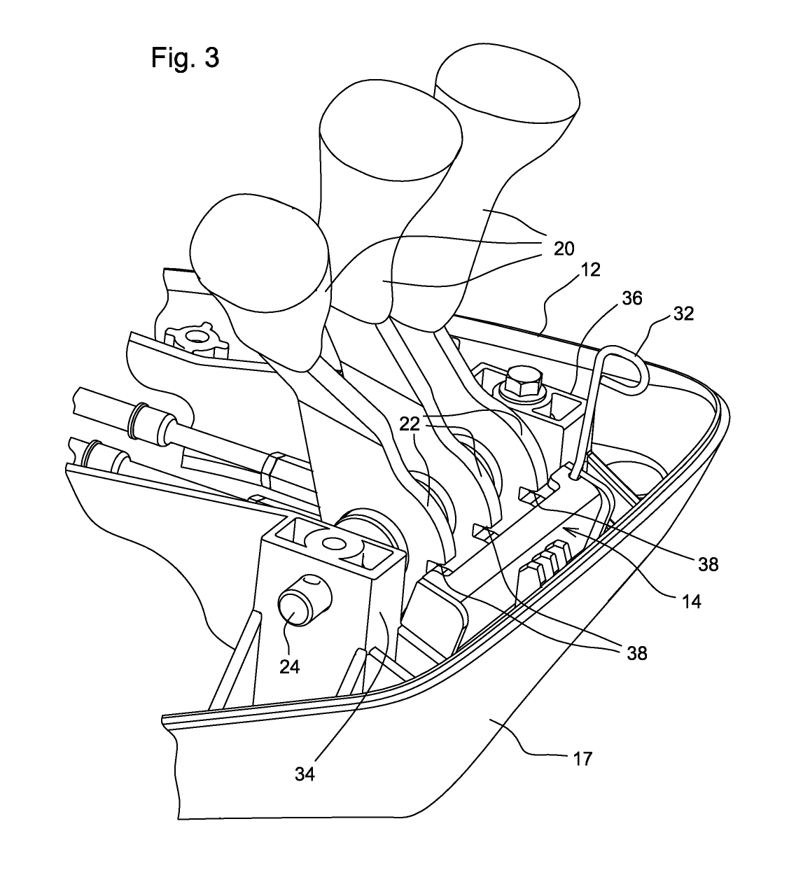

As best seen in FIGS. 2 and 3, the ends of pivot pin 24 are supported by a pair of support blocks 34, 36 which are formed by the housing 12. A lever lockout slot 38 is formed in the lower part or base 22 of each lever 20. In FIG. 2, the lockout member is shown in its lockout position wherein a portion of the lockout member 14 is received by the slots 38. In FIG. 3, the lockout member 14 is shown in its unlocked position wherein a portion of the lockout member 14 is withdrawn from the slots 38.

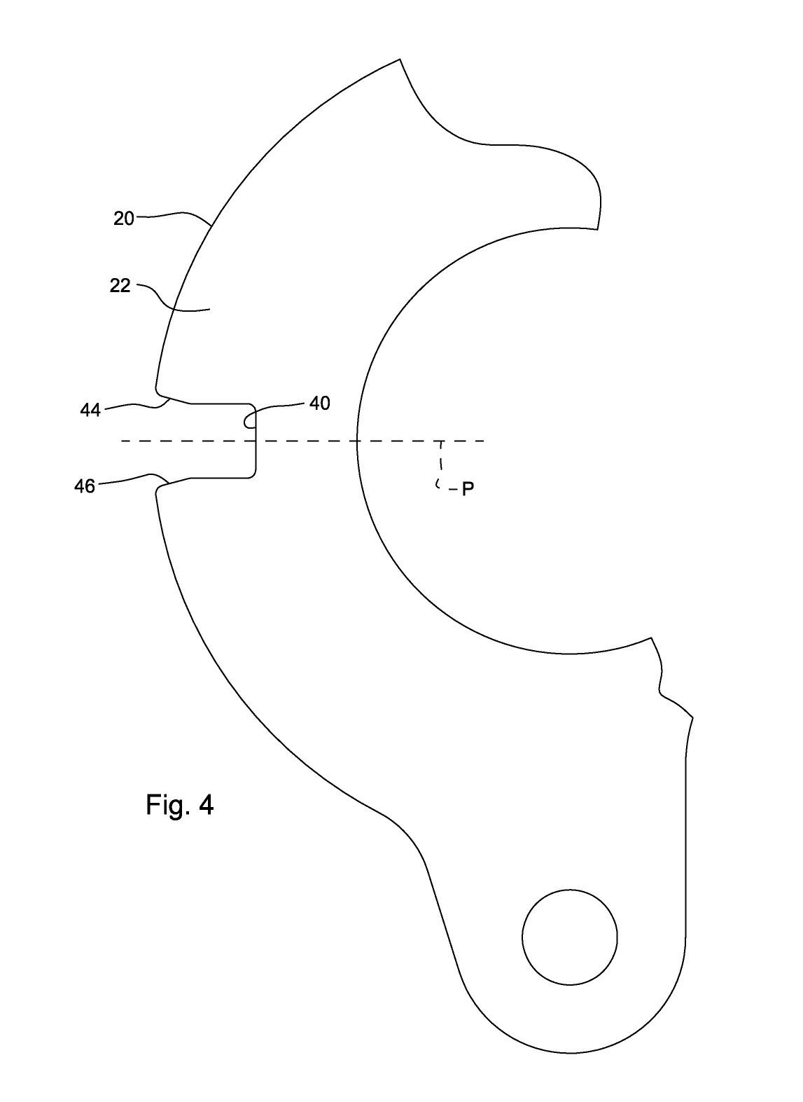

As best seen in FIG. 4, each slot 38 is preferably centered on a plane P which contains the pivot axis of pivot pin 24. Each slot 38 has an upwardly slanted upper lip 44, and a downwardly slanted lower lip 46. Each lip 44 and 46 is preferably tilted by 15 degrees with respect to the plane P, so that the mouth of each slot 38 is wider at its outer end. This wider mouth enhances the ease of alignment of each individual lever slot 38 with the lockout member 14 as it is rotated to the lock position. The width of the slots has some clearance with respect to the thickness of the lockout member 14 to ensure that the lockout member 14 can be inserted into and removed from the slots 38. This clearance should preferably be set small enough to prevent the lever 20 from rotating enough to actuate the valve (not shown) to which it is operatively connected.

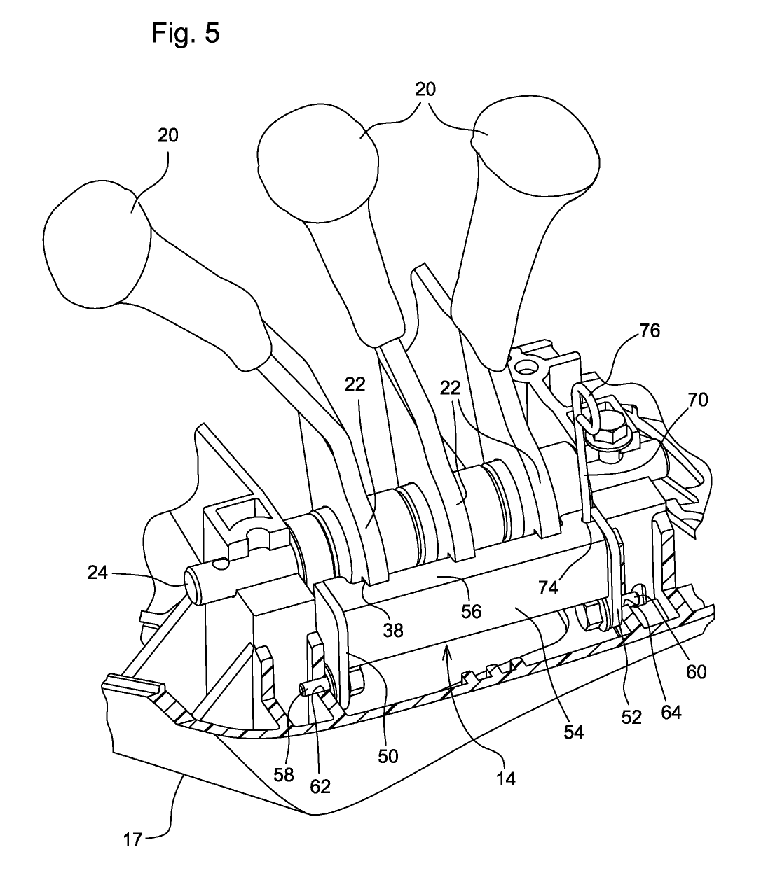

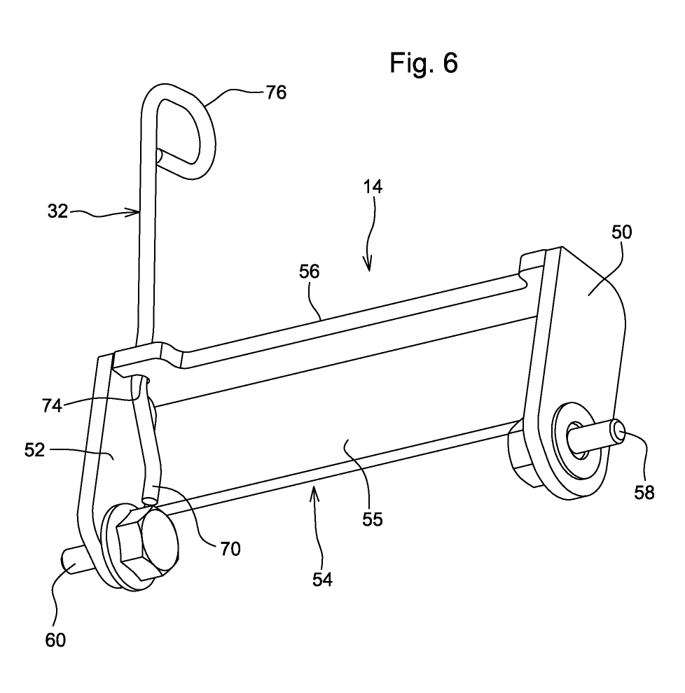

As best seen in FIGS. 5 and 6, the lockout member 14 has a pair of end walls 50 and 52 attached to opposite ends of lockout plate 54. Plate 54 has an upside down L-shaped cross sectional shape, and has a main part 55 and a lip 56 which is bent and extends generally perpendicularly at an upper end of main part 55. The lip 56 is the part of the lockout member 14 which is received by the slots 38. Pivot pins 58 and 60 project outwardly from a lower portion of the end walls 50 and 52, respectively. The pivot pins 58, 60 are preferably screws or bolts which are inserted through threaded holes in the end walls 50, 52, and into pivot bores 62, 64 formed in a lower part of housing 12.

As best seen in FIG. 6, the spring arm 32 has a lower end 70 which engages the end wall 52 and an end of plate 54. The lower end 70 may be brazed or welded to the end wall 52. Spring arm 32 passes through an aperture 74 formed between the lip 56 and the upper end of end wall 52. A loop at the top of spring arm 32 forms a handle 76.

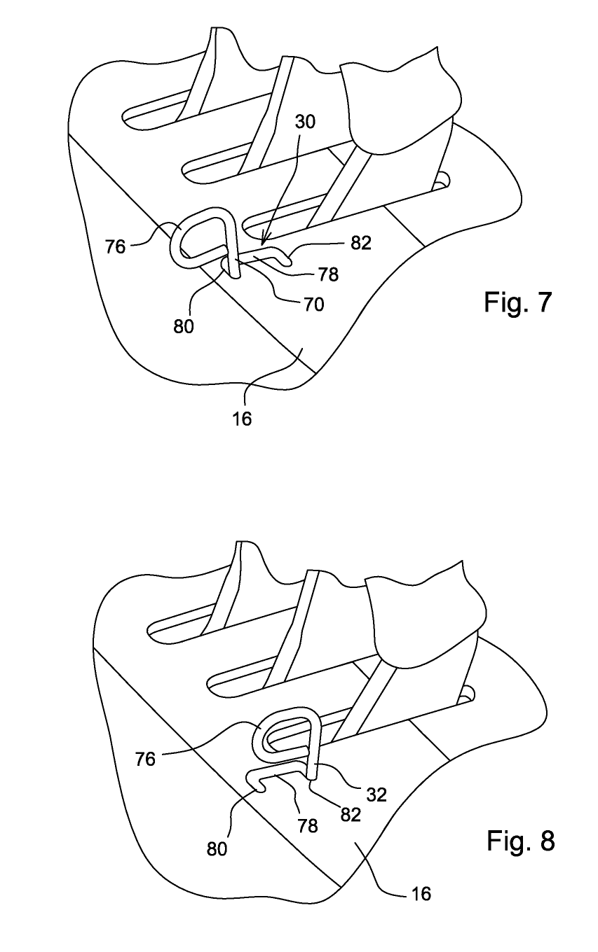

As best seen in FIGS. 7 and 8, the spring arm slot 30 has a “U” shape with a main slot portion 78, a first or unlocked end slot 80 and a second or locked end slot 82. The spring arm 32 passes through the U-shaped slot 30 in the upper cover 16. When the lockout member 14 is in its unlocked position, spring arm 32 will be received in first end slot 80. When the lockout member 14 is in its lockout position, spring arm 32 will be received in second end slot 82. Spring arm is biased so that it is urged against the ends of ends slots 80 and 82 when it is released by an operator.

The operator can flex the spring arm 32 to the left viewing FIGS. 7 and 8, to move the spring arm 32 into the main slot portion 78 so that the spring arm 32 can be moved between the locked and unlocked positions. To move the locking member 14 to the “locked” position, the operator flexes the spring arm 32 into the slot 78 ad then into end slot 82. This rotates the locking member 14 so that lip 56 is received by the notches 40 in the levers 20, thus locking them in a neutral position and preventing oil flow through the valves (not shown) coupled thereto. The spring arm 32 is biased slightly to both the locked and unlocked positions by its engagement with the wall 56 and the aperture 74. This prevents the locking member 14 from rattling due to vibrations inherent in the operation of an agricultural vehicle. This lever lockout assembly can be used on a tractor with one or multiple control levers.

The upper cover 16 receives loads for the flexing of the spring arm 32. The load from the operator inadvertently trying to move a lever 20 with the lock engaged would be transferred through the locking member assembly to the lower cover 17 through the pivot pins 58 and 60. The lower cover 17 is preferably made out of a structural plastic designed to take the loads placed on the levers 20.

This lockout assembly meets the selective control valve lockout homologation requirements in various countries, and enables an operator to lock or unlock all of the SCV levers in a console. It accomplishes this with a rotating locking member assembly with a few parts. After the cables are assembled to the valves and control levers 20, the levers 20 can be locked to the neutral position. The cable length for each control can be adjusted to the proper length for the neutral position of the valve. After the adjustments are completed, a cable end locking clip (not shown) is installed. This reduces the number of adjustment iterations required during initial assembly or service. This new design uses a robust pivoting locking member that is capable of withstanding the loads an operator may put into the system.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A lever lockout assembly, comprising:
a housing;
a lever support mounted on the housing;
a lockout support mounted on the housing;
a lever member having a pivot plate and an arm projecting from the pivot plate, the pivot plate being rotatably supported by the lever support, and the pivot plate having notch formed in an outer surface thereof; and
a lockout member pivotally supported by the lockout support, the lockout member having an arm extending transversely with respect to a pivot axis of the lockout member, the lockout member being pivotal to a lockout position wherein the arm is received by the notch, and the lockout member being pivotal to an unlocked position wherein the arm is outside of the notch and the pivot plate is rotatable.

2. The lever lockout assembly of claim 1, wherein:
a lockout spring member projects from the lockout member; and
the housing includes a cover, the cover having a lockout slot through which extends the lockout spring member.

3. The lever lockout assembly of claim 2, wherein:
the lockout slot is a U-shaped slot having a main slot and first and second end slots extending transversely with respect to the main slot.

4. The lever lockout assembly of claim 3, wherein:
the lockout spring member is biased to engage an end of the first end slot when the lockout member is in the unlocked position; and
the lockout spring member is biased to engage an end of the second end slot when the lockout member is in the locked position.

5. The lever lockout assembly of claim 1, wherein:
the lockout member has a substantially L-shaped cross sectional shape.

6. The lever lockout assembly of claim 1, wherein:
the lockout member has an inner arm and a outer arm extending transversely with respect to the inner arm,

7. The lever lockout assembly of claim 6, wherein:
the notch is centered on a plane which extends radially from a pivot axis of the lever member.

8. The lever lockout assembly of claim 1, wherein:
the lockout member comprises a lockout plate having a first portion joined to a second portion by a bent portion.

9. The lever lockout assembly of claim 8, wherein:
the lockout member comprises a pair of end members, the lockout plate extending between the end members.

10. The lever lockout assembly of claim 9, wherein:
a lockout spring member projects from one of the end members; and
the housing includes a cover, the cover having a lockout slot through which extends the lockout spring member.

11. A lever lockout assembly, comprising:
a housing;
a lockout slot formed in the housing;
a lever support mounted on the housing;
a lockout support mounted on the housing;
a lever member having a pivot plate and an arm projecting from the pivot plate, the pivot plate being rotatably supported by the lever support, and the pivot plate having notch formed in an outer surface thereof;
a lockout spring member projecting from the lockout member and extending through the lockout slot; and
a lockout member pivotally supported by the lockout support, the lockout member having an inner arm and a outer arm extending transversely with respect to the inner arm, the lockout member being pivotal to a lockout position wherein the outer arm is received by the notch, and the lockout member being pivotal to an unlocked position wherein the outer arm is outside of the notch and the pivot plate is rotatable.

12. The lever lockout assembly of claim 11, wherein:
the lockout slot is a U-shaped slot having a main slot and first and second end slots extending transversely with respect to the main slot.

13. The lever lockout assembly of claim 12, wherein:
the lockout spring member is biased to engage an end of the first end slot when the lockout member is in the unlocked position; and
the lockout spring member is biased to engage an end of the second end slot when the lockout member is in the locked position.
